(19) United States
(12) Patent Application Publication
(10) Pub. No.: US 2025/0021028 A1
(43) Pub. Date: Jan. 16, 2025

(54) TONER PRODUCING METHOD

(71) Applicant: CANON KABUSHIKI KAISHA, Tokyo (JP)

(72) Inventors: DAISUKE YAMASHITA, Chiba (JP); HISASUKE KAJIHARA, Ibaraki (JP); YOSUKE IWASAKI, Chiba (JP); KOUICHIROU OCHI, Chiba (JP); TAKESHI OHTSU, Ibaraki (JP); KOH ISHIGAMI, Chiba (JP)

(21) Appl. No.: 18/764,439

(22) Filed: Jul. 5, 2024

(30) Foreign Application Priority Data
Jul. 10, 2023 (JP) 2023-112858

(51) Int. Cl. G03G 9/08

(52) U.S. Cl. CPC G03G 9/081; G03G 9/0815; G03G 9/0819

(57) ABSTRACT

A method of producing a toner, the method comprising: a melt-kneading step of melt-kneading a mixture A comprising a binder resin, and a material to be dispersed over the binder resin to yield a kneaded product, wherein the mixture A comprises 1.0 to 10.0 parts by mass of water to 100.0 parts by mass of the binder resin and the material to be dispersed in total, the water comprised in the mixture A comprises bubbles comprising ultrafine bubbles having a particle diameter of not more than 1000 nm, and the number of the ultrafine bubbles comprised in the water comprised in the mixture A is at least 1.0×10⁴ per milliliter.

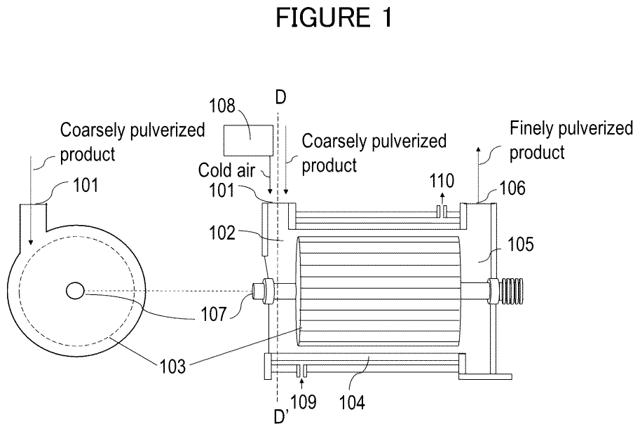

### BACKGROUND OF THE INVENTION

### Field of the Invention

The present disclosure relates to a method of producing a toner which is used for an electrophotographic system, an electrostatic recording system, an electrostatic printing system, and a tonner jet system.

### Description of the Related Art

In recent years, more and more full-color multifunction printers using an electrophotographic system are used, and application thereof in the printing market has been progressing. In the printing market, high speed, high-resolution images, high productivity, and low running costs have been demanded while coping with wide range of media (kinds of paper). As to toner, tinting strength can be improved by improving dispersibility of colorants in the toner, and an improvement in resolution of images can be achieved by further reducing the particle diameter of the toner.

As a general method of producing a toner particle, a melt-kneading pulverization method is known. This method is specifically a method for melt-kneading, and cooling and solidifying toner components such as a binder resin, a colorant, and a release agent, and thereafter, micronizing the kneaded product by using a pulverizing means to yield a toner particle. Thereafter, if necessary, the obtained toner particle is classified according to a desired particle size distribution, and an external additive such as a fluidizing agent is added thereto to produce toner.

For improving the tinting strength of toner, for example, Japanese Patent Application Publication No. 2005-352131, Japanese Patent Application Publication No. 2003-098739, and Japanese Patent Application Publication No. 2002-072554 each propose a technique of kneading a resin, water, and a pigment in a melt-kneading step of a toner producing step, and thereby, dispersing the pigment to improve color reproduction/tinting strength.

In contrast, for reducing the particle diameter of toner, finer micronization is necessary in the step of finely pulverizing the kneaded product. Generally, there is a concern that finer pulverization causes lower productivity. Therefore, highly efficient pulverizing means or apparatuses for maintaining productivity and for suppressing energy consumption are demanded. Japanese Patent Application Publication No. 2008-191491, and Japanese Patent Application Publication No. 2015-132645 each propose adding a pulverizing aid into the kneaded product of toner as a means of making the kneaded product of toner easily pulverized, and thereby, achieving an improvement in efficiency of the pulverization without any investment in production equipment.

### SUMMARY OF THE INVENTION

For improving tinting strength, it is effective to increase the hiding power of a colorant such as a pigment over media. However, the pigment dispersibility in the toner particle disclosed in any of the aforementioned Japanese Patent Application Publication No. 2005-352131, Japanese Patent Application Publication No. 2003-098739, and Japanese Patent Application Publication No. 2002-072554 is not considered to be enough to yield a high hiding power, and has room for improvement. Therefore, a technique of microdispersing a material to be dispersed, such as a pigment, over a binder resin at a higher degree is demanded.

As in Japanese Patent Application Publication No. 2008-191491, and Japanese Patent Application Publication No. 2015-132645, a means of containing, as a pulverizing aid, an inorganic fine particle etc., in the kneaded product of toner as a pulverizing aid, and finely pulverizing the resultant is known as a means of reducing the particle diameter of the toner. However, the residue of the pulverizing aid in the toner may affect the performance of the toner, so that a pulverizing aid cannot be used when only the particle diameter of a toner of the existing formulation is desired to be reduced.

The present disclosure is directed to a method of producing a toner that allows a material to be dispersed to be microdispersed over a binder resin to a higher degree. For example, the present disclosure is directed to a method of producing a toner of excellent tinting strength, and a method of producing a toner that can improve toner pulverizability without any residue of a pulverizing aid etc.

The present disclosure relates to a method of producing a toner, the method comprising:
a melt-kneading step of melt-kneading a mixture A comprising a binder resin, and a material to be dispersed over the binder resin to yield a kneaded product, wherein
the mixture A comprises 1.0 to 10.0 parts by mass of water to 100.0 parts by mass of the binder resin and the material to be dispersed in total,
the water comprised in the mixture A comprises bubbles comprising ultrafine bubbles having a particle diameter of not more than 1000 nm, and
the number of the ultrafine bubbles comprised in the water comprised in the mixture A is at least 1.0×10⁴ per milliliter.

According to the present disclosure, a toner producing method that allows a material to be dispersed to be microdispersed over a binder resin to a higher degree can be provided. For example, according to the present disclosure, a method of producing a toner of excellent tinting strength, and a toner producing method that can improve toner pulverizability without any residue of a pulverizing aid etc. can be provided. Further features of the present invention will become apparent from the following description of exemplary embodiments with reference to the attached drawings.

### BRIEF DESCRIPTION OF THE DRAWINGS

The FIGURE is a schematic view of a mechanical pulverizer.

### DESCRIPTION OF THE EMBODIMENTS

In the present specification, the term “from XX to YY” or “XX to YY” indicative of the numerical value range means the numerical value range including the lower limit and the upper limit, i.e., the endpoints unless otherwise specified. Further, when the numerical value range is described in steps, the upper limits and the lower limits of respective numerical value ranges can be arbitrarily combined.

The present disclosure relates to a method of producing a toner, the method comprising:
a melt-kneading step of melt-kneading a mixture A comprising a binder resin, and a material to be dispersed over the binder resin to yield a kneaded product, wherein
the mixture A comprises 1.0 to 10.0 parts by mass of water to 100.0 parts by mass of the binder resin and the material to be dispersed in total,
the water comprised in the mixture A comprises bubbles comprising ultrafine bubbles having a particle diameter of not more than 1000 nm, and
the number of the ultrafine bubbles comprised in the water comprised in the mixture A is at least 1.0×10⁴ per milliliter.

According to the foregoing toner producing method, a material to be dispersed over a binder resin can be microdispersed to a higher degree. Therefore, for example, a method of producing a toner of excellent tinting strength can be provided. For example, a toner producing method that can improve toner pulverizability without any residue of a pulverizing aid etc. can be also provided. The inventors of the present disclosure think of the reason for this as follows.

Conventionally, in melt-kneading using a thermal kneader such as a pressure kneader and a continuous extruder, a mixture of toner components such as a binder resin, a pigment as a colorant, and a release agent are mixed with each other by receiving shear from the apparatus while the temperature gradually rises due to heating from this kneader at the same time; thereby, the mixture forms a kneaded product. At this time, the secondary particle of the pigment, which is a material to be dispersed over the binder resin, is deagglomerated by the shear from the apparatus, and likewise, the release agent, which is a material to be dispersed, is fractured by the shear from the apparatus; thereby, the pigment microdisperses in the kneaded product.

In the present disclosure, when melt-kneading is performed, the water comprising the bubbles comprising the ultrafine bubbles (UFB) (hereinafter also referred to as the “UFB water”) is comprised in the mixture A, which is a raw material mixture comprising the binder resin, and the material to be dispersed over the binder resin. By comprising the UFB water in the mixture A, the material to be dispersed can be microdispersed in the binder resin to a higher degree than the case where no UFB water is comprised. UFB is a bubble having a size of, for example, approximately several ten nanometers to 1 μm (1000 nm), and does not move upward but can stably remain for a long time in water.

The following can be assumed as a mechanism such that the material to be dispersed can be microdispersed to a high degree in melt-kneading by comprising the UFB water in the mixture A. UFB present in water can take a compressive breaking action and a surface action. The compressive breaking action is an action of, when physical force is applied from the outside, contracting a bubble, rapidly increasing the pressure in the bubble, and emitting a shock wave when the bubble vanishes. When the UFB water is mixed in the raw material mixture A, the UFB is adsorbed on the surfaces of the binder resin and the material to be dispersed by the surface action. Further, it is considered that a stronger external force than conventional kneading can be applied to the material to be dispersed by shock waves emitted by compressive breaking of the UFB that is caused by shear in kneading, so that the material to be dispersed can be highly efficiently micronized and microdispersed.

For example, when a pigment is comprised as the material to be dispersed, it is considered that the pigment further microdisperses in the toner, and a hiding power for light is improved; thereby, chromogenicity is improved and tinting is further improved. Therefore, the material to be dispersed preferably comprises a pigment.

For example, when a release agent is comprised as the material to be dispersed, a release agent is further microdisperses over the kneaded product of the toner components. In the kneaded product, places where the release agent is present tend to become cross sections in pulverization. Thus, in the pulverizing step after the kneading, efficiency of the pulverization improves. Therefore, toner pulverizability can be improved without any residue of a pulverizing aid etc. Therefore, the material to be dispersed preferably comprises a release agent.

In addition, for example, when a pigment and a release agent are comprised as the material to be dispersed, the pigment further microdisperses in the toner; thereby, tinting strength can be improved. Moreover, the microdispersion of the release agent can improve toner pulverizability. Therefore, the material to be dispersed preferably comprises a pigment and a release agent.

By the above mechanism, the toner producing method that allows the material to be dispersed over the binder resin to be microdispersed to a higher degree can be considered to be provided according to the present disclosure. The material to be dispersed is not limited to a pigment or a release agent as long as the aforementioned compressive breaking action and surface action can be taken. Examples of the material to be dispersed include a plasticizer, a charge control agent, a colorant other than a pigment; and a resin particle and an inorganic particle that are to be contained inside a toner particle.

First, ultrafine bubble water (UFB water) will be described.

### Ultrafine Bubble

A bubble having a particle diameter of at least 100 μm (submillimeter bubble) moves upward in water, and vanishes on a gas-liquid interface. A bubble having a particle diameter of larger than 1 μm and smaller than 100 μm (microbubble) cannot resist water pressure and tends to vanish in water while the upward rate thereof in water decreases. Against them, an ultrafine bubble having a particle diameter of not more than 1 μm (1000 nm) (nanobubble) can be stably present in water even for several months. When extremely fine bubbles such as ultrafine bubbles as the above are contained in a raw material mixture when the toner or a masterbatch is produced, the dispersibility of the material to be dispersed can be improved by a compressive breaking effect and a surface action.

The bubble is preferably constituted of at least one gas selected from the group consisting of a rare gas, an oxygen gas, a nitrogen gas, carbon dioxide, an ozone gas, and air. Among them, at least one gas selected from the group consisting of an oxygen gas, a nitrogen gas, carbon dioxide, an ozone gas, and air is preferable. Particularly, the gas constituting the bubble is preferably air. Air is preferable because, in the case of air, it is not necessary for a bubble generator to be accompanied with any devices (a gas generator, and a storage device such as a gas cylinder).

Particularly, it is necessary for the mixture A, which is a mixture of the raw materials of the toner particle, to comprise 1.0 to 10.0 parts by mass of water to 100.0 parts by mass of the binder resin and the material to be dispersed in total. The water comprised in the mixture A is the UFB water that comprises the bubbles comprising the undermentioned specific UFB.

When the ultrafine bubble-containing water is less than 1.0 parts by mass, the liquid does not diffuse enough over the surface of the materials. Thus, the points of the compressive breaking action become less, and the effect of diffusing the material to be dispersed may not be sufficiently exerted. On the contrary, when the ultrafine bubble-containing water is more than 10.0 parts by mass, the amount of the water present among the materials is so large that the shear from a kneader is difficult to sufficiently work on the raw materials. Therefore, the effect of dispersing the material to be dispersed does not improve.

The content of the water to 100.0 parts by mass of the binder resin and the material to be dispersed in total is preferably 2.0 to 8.0 parts by mass. When, for example, the undermentioned masterbatch is once produced in the process of producing the toner, the raw material mixture may be melt-kneaded a plurality of times. Usually, the contained water is considered to vaporize through melt-kneading. Therefore, when the mixture is subjected to melt-kneading a plurality of times, 1.0 to 10.0 parts by mass of the UFB water to 100.0 parts by mass of the binder resin and the material to be dispersed in total are preferably mixed with the mixture in melt-kneading each time.

The water comprised in the mixture A comprises the bubbles comprising the ultrafine bubbles having a particle diameter of not more than 1000 nm. It is necessary that the number of the ultrafine bubbles, which have a particle diameter of not more than 1000 nm, comprised in the water comprised in the mixture A is at least 1.0×10⁴ per milliliter (hereinafter this content will be also referred to as the “UFB number density”). When the UFB number density is less than 1.0×10⁴ per milliliter, the amount of the UFB having adhered to the surface of the material to be dispersed is not enough. Therefore, a compressive breaking effect or surface action enough to deagglomerate the material to be dispersed is considered not to be obtained in melt-kneading. Thus, the material to be dispersed is considered to be unable to be microdispersed to a higher degree. Because of this, it is necessary for the number density of the bubbles to be at least 1.0×10⁴ per milliliter, preferably at least 5.0×10⁶ per milliliter.

In contrast, in view of productivity, preferably, the UFB number density is not more than 3.0×10¹⁰ per milliliter. The UFB number density is preferably 1.0×10⁴ to 3.0×10¹⁰ per milliliter, and more preferably 5.0×10⁶ to 3.0×10¹⁰ per milliliter.

Further, in the water comprised in the mixture A, the number-average particle diameter of the bubbles is preferably not more than 1000 nm. When the number-average particle diameter of the bubbles comprised in the water is not more than 1000 nm, the bubbles tend to each have a smaller diameter than a diameter that leads to Brownian motion, and therefore, are easy to be present more stably. Therefore, the bubbles can be present more sufficiently after mixing with the binder resin and the material to be dispersed until the mixture is put into a kneader. When this number-average particle diameter is within the foregoing range, the contact points of the bubbles with the surface of the material to be dispersed is more. Therefore, a more sufficient compressive breaking effect or surface action for deagglomerating the material to be dispersed is considered to be easily obtained. Thus, the material to be dispersed is considered to be microdispersed to a higher degree easily.

Because of the foregoing, the number-average particle diameter of the bubbles comprised in the added water is preferably not more than 1000 nm, and more preferably not more than 700 nm. The lower limit of this particle diameter is not particularly limited. The number-average particle diameter of the bubbles is, for example, preferably 10 to 1000 nm, more preferably 50 to 1000 nm, further preferably 10 to 700 nm, further more preferably 50 to 700 nm, and particularly preferably 100 to 700 nm.

The particle diameter of the UFB, and the UFB number density are measured by a laser diffraction and scattering method. The particle diameter of the bubbles is a number-average particle diameter. The UFB number density is the ratio of the bubbles having a particle diameter of not more than a predetermined value per the volume of the water (per milliliter). In the undermentioned examples, the particle diameter of the bubbles was calculated with a nano particle size distribution analyzer (trade name: SALD-7500nano, manufactured by Shimadzu Corporation).

In addition, the number density of the UFB of not more than 1000 nm was calculated using a nanoparticle tracking particle diameter measuring instrument (trade name: NanoSight NS300, manufactured by Malvern Panalytical) that allowed the particle number to be observed by imaging scattered light by laser irradiation via a camera.

As for the means of producing the UFB-containing water, a known method may be used without any particularly restrictions as long as water containing bubbles which satisfies a desired particle diameter and a desired particle concentration can be produced. For example, the UFB-containing water can be produced using a known device adapted to generate water which contains fine bubbles, such as the fine bubble generation nozzle disclosed in Japanese Patent Application Publication No. 2014-104441; and the fluid mixer disclosed in WO 2009/088085. Water that contains bubbles having a particle size distribution controlled to be in a desired range can be obtained by appropriately setting the conditions for using such a device.

For example, the bubble-containing water can be also produced by imparting thermal energy to the liquid to cause film boiling to generate bubbles as disclosed in Japanese Patent Application Publication No. 2019-42732. Water that contains bubbles having a particle size distribution controlled to be in a desired range can be obtained by appropriately setting, for example, the conditions for the film boiling.

The UFB number density can be adjusted by setting the UFB water in a reduced pressure, and thereby, removing part of the water to concentrate the UFB-containing water as disclosed in Japanese Patent Application Publication No. 2022-144980. Further, the UFB may be prepared using commercially available (study) bubble-containing water (such as “high-density ultrafine bubble” and “ultrahigh-density ultrafine bubble” (both trade names, and manufactured by NANOX CO., LTD.)). The masterbatch and the toner are produced by adding the obtained UFB to the mixture A in the step of mixing the raw materials before melt-kneading.

### Binder Resin

The toner particle comprises the binder resin. A known polymer may be used as the binder resin. Specifically, for example, any of the following polymers may be used: a homopolymer of styrene and a substitution product thereof, such as polystyrene, poly-p-chlorostyrene, and polyvinyltoluene; a styrene-based copolymer such as a styrene-p-chlorostyrene copolymer, a styrene-vinyltoluene copolymer, a styrene-vinylnaphthalene copolymer, a styrene-acrylate copolymer, a styrene-methacrylate copolymer, a styrene-methyl α-chloromethacrylate copolymer, a styrene-acrylonitrile copolymer, a styrene-vinyl methyl ether copolymer, a styrene-vinyl ethyl ether copolymer, a styrene-vinyl methyl ketone copolymer, and a styrene-acrylonitrile-indene copolymer; polyvinyl chloride, a phenolic resin, a natural resin modified phenolic resin, a natural resin modified maleic acid resin, an acrylic resin, a methacrylate resin, polyvinyl acetate, a silicone resin, a polyester resin, a polyurethane resin, a polyamide resin, a furan resin, an epoxy resin, a xylene resin, polyvinyl butyral, a terpene resin, a coumarone-indene resin, or a petroleum resin. One of these resins may be used alone, or two or more of these resins may be used in combination.

Among them, an amorphous polyester resin is preferable. An amorphous polyester resin as used herein is preferably a condensation polymer of a carboxylic acid component and an alcohol component. Known ones may be used as a carboxylic acid component and an alcohol component as used herein. The carboxylic acid component preferably contains at least one selected from the group consisting of terephthalic acid and fumaric acid. The alcohol component preferably contains an alkylene oxide adduct of bisphenol A (the average addition mol number is preferably 1 to 5 mol). As the acid component, tricarboxylic acid such as trimellitic acid may be used.

For the binder resin, a polyester resin L of a low softening point, and a polyester resin H of a high softening point may be mixed and used. The content ratio (L/H) of a polyester resin L of a low softening point, and a polyester resin H of a high softening point as used herein is, for example, 60/40 to 90/10 on the mass basis. Preferably, the softening point of the polyester resin L of a low softening point is at least 70° C. and lower than 100° C. Preferably, the softening point of the polyester resin H of a high softening point is from 100° C. to 160° C.

The binder resin may contain a crystalline polyester resin in view of compatibility of low-temperature fixability and an anti-blocking property with each other. A crystalline polyester resin as used herein is preferably a condensation polymer of an alcohol having an aliphatic diol of a carbon number from 2 to 23, and carboxylic acid having an aliphatic dicarboxylic acid of a carbon number from 4 to 24.

This crystalline polyester resin is more preferably a condensation polymer of the following alcohol and the following carboxylic acid: the content of an aliphatic diol having a carbon number from 4 to 12 in the alcohol is from 80 mol % to 100 mol % (further preferably, from 85 mol % to 100 mol %) of the total alcohol constituting the crystalline polyester resin; and the content of an aliphatic dicarboxylic acid having a carbon number from 4 to 20 in the carboxylic acid is from 80 mol % to 100 mol % (further preferably, from 85 mol % to 100 mol %) of the total carboxylic acid constituting the crystalline polyester resin.

An aliphatic diol as used herein is preferably a linear chain aliphatic diol, and examples thereof include 1,4-butanediol, 1,5-pentanediol, 1,6-hexanediol, 1,7-heptanediol, 1,8-octanediol, 1,9-nonanediol, 1,10-decanediol, and 1,12-dodecanediol, and derivatives thereof. The derivatives are not particularly limited as long as the same resin structure is obtained by condensation polymerization. An example of the derivatives is a derivative obtained by esterifying any of the foregoing diols.

An aliphatic dicarboxylic acid as used herein is preferably a linear chain aliphatic dicarboxylic acid, and examples thereof include malonic acid, succinic acid, glutaric acid, adipic acid, pimelic acid, suberic acid, glutaconic acid, azelaic acid, sebacic acid, hexadecanedioic acid, and eicosanedioic acid, and derivatives thereof. The derivatives are not particularly limited as long as the same resin structure is obtained by condensation polymerization. Example of the derivatives include acid anhydrides of any of the dicarboxylic acids, and derivatives obtained by alkyl esterifying or acid chloriding a dicarboxylic acid component.

In contrast, the carboxylic acid may be used in combination with a carboxylic acid other than the foregoing aliphatic dicarboxylic acids.

### Colorant

The toner particle may comprise a colorant. That is, the material to be dispersed may comprise a colorant, and preferably comprises a pigment. A colorant such as a pigment is usually comprised except the case where the undermentioned clear toner is produced. Examples of a pigment as used herein include known organic pigments, carbon black, and magnetic bodies.

Examples of a cyan pigment as used herein include copper phthalocyanine compounds and derivatives thereof, anthraquinone compounds, and base dye lake compounds; specifically, C.I. Pigment Blue 1, 7, 15, 15:1, 15:2, 15:3, 15:4, 60, 62 and 66.

Examples of a magenta pigment as used herein include condensed azo compounds, diketopyrrolopyrrole compounds, anthraquinone compounds, quinacridone compounds, base dye lake compounds, naphthol compounds, benzimidazolone compounds, thioindigo compounds, and perylene compounds; specifically, C.I. Pigment Red 2, 3, 5, 6, 7, 23, 48:2, 48:3, 48:4, 57:1, 81:1, 122, 144, 146, 166, 169, 177, 184, 185, 202, 206, 220, 221 and 254, and C.I. Pigment Violet 19.

Examples of a yellow pigment as used herein include condensed azo compounds, isoindolynone compounds, anthraquinone compounds, azometal complexes, methine compounds, and allylamide compounds; specifically, C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 191 and 194.

Examples of a black pigment as used herein include carbon black, magnetic bodies, and materials subjected to color matching to be black using any of the aforementioned yellow pigments, magenta pigments and cyan pigments.

Examples of a white pigment as used herein include titanium oxide, magnesium oxide, aluminum oxide, zinc oxide, barium sulfate, calcium carbonate, calcium titanate, strontium titanate, silica, clay, and talc.

One of the aforementioned pigments may be used alone, or two or more thereof may be mixed and used. Preferably, the colorant, which can be also used in the form of a solid solution, is selected in view of hue angles, chroma, lightness, lightfastness, OHP transparency, and dispersibility over the toner particle.

The content of the colorant (pigment) in the mixture A (or the undermentioned first mixture or second mixture) is preferably 1 to 60 parts by mass, more preferably 1 to 20 parts by mass, and further preferably 5 to 15 parts by mass to 100 parts by mass of the binder resin. When the undermentioned masterbatch is produced, that is, when the mixture A is the first mixture, the content of the colorant is preferably 20 to 60 parts by mass, and more preferably 30 to 55 parts by mass to 100 parts by mass of the binder resin.

When the pigment is any of the cyan, magenta, yellow, and black pigments, this content is preferably from 1 to 20 parts by mass to 100 parts by mass of the binder resin. When the pigment is the white pigment, this content is preferably from 20 to 50 parts by mass to 100 parts by mass of the binder resin in view of hiding a base color for expressing a white color enough so that the base color cannot be recognized.

An example of a toner comprising no pigment or colorant is a clear toner for brightening by melting the clear toner on a print media. In the case of a clear toner, the diameter can be easily reduced by containing a release agent in the toner as described above.

### Release Agent

The toner particle may comprise a release agent. That is, the material to be dispersed may comprise a release agent. The following are examples of a release agent as used herein:
hydrocarbon waxes such as low molecular weight polyolefins (low molecular weight polyethylene, and low molecular weight polypropylene), alkylene copolymers, ceresin, paraffin waxes, microcrystalline waxes, and Fischer-Tropsch wax; silicones having a melting point; fatty acid amides such as oleic acid amide, erucic acid amide, ricinoleic acid amide, and stearic acid amide; ester waxes such as stearyl stearate; plant-based waxes such as carnauba wax, rice wax, candelilla wax, Japan wax, and jojoba oil; animal waxes such as bees wax; mineral and petroleum waxes such as montan wax, ozokerite, and ester waxes; and modified products thereof.

As the release agent, one of the foregoing may be used alone, or two or more thereof may be mixed and used. The release agent preferably contains a hydrocarbon wax. The melting point of the release agent is preferably not more than 150° C., more preferably from 40° C. to 130° C., and further preferably from 40° C. to 110° C. The content of the release agent in the mixture A (or the undermentioned second mixture) is preferably 1 to 30 parts by mass, more preferably 2 to 20 parts by mass, and further preferably 5 to 15 parts by mass to 100 parts by mass of the binder resin.

### Charge Control Agent

A charge control agent can be also contained in the toner if necessary. A known charge control agent may be used. Particularly, a metallic compound of an aromatic carboxylic acid that is colorless, provides a fast charging speed of the toner, and can stably hold a certain charge quantity is preferable.

The following are examples of a negative charge control agent: salicylic acid metal compounds, naphthoic acid metal compounds, dicarboxylic acid metal compounds, polymeric compounds each having sulfonic acid or carboxylic acid in the side chain, polymeric compounds each having a sulfonic acid salt or a sulfonic acid ester in the side chain, polymeric compounds each having a carboxylic acid salt or a carboxylic acid ester in the side chain, boron compounds, urea compounds, silicon compounds, and calixarenes.

Examples of a positive charge control agent as used herein include quaternary ammonium salts, polymeric compounds each having any of the quaternary ammonium salts in the side chain, guanidine compounds, and imidazole compounds. The charge control agent may be added either internally or externally to the toner particle.

The amount of the charge control agent added is preferably from 0.2 parts by mass to 10 parts by mass to 100 parts by mass of the binder resin.

### Developer

While able to be used as a one-component developer, the toner is preferably mixed with a magnetic carrier and used as a two-component developer in order to further improve dot reproducibility, and because stable images are obtained for a long time.

As a magnetic carrier as used herein, any of known ones as the following may be used: surface-oxidized iron powders; unoxidized iron powders; metal particles, alloy particles, and oxide particles of iron, lithium, calcium, magnesium, nickel, copper, zinc, cobalt, manganese, chromium, rare earths, etc.; magnetic bodies such as ferrite; and magnetic body-dispersed resin carriers (so-called resin carriers) containing magnetic bodies, and binder resins that hold the magnetic bodies in a dispersed state.

Usually, good results are obtained when the mixing ratio of the carrier is preferably from 2 mass % to 15 mass %, and more preferably from 4 mass % to 13 mass % on the basis of the toner concentration in the two-component developer when the toner is mixed with the magnetic carrier and used as a two-component developer.

### Method of Producing Toner

The steps of producing the toner will be described.

The toner producing method is not particularly limited as long as the UFB water is comprised in the mixture A, which is a mixture comprising the binder resin and the material to be dispersed over the binder resin, such as the colorant and the release agent, and as long as the method comprises the melt-kneading step of melt-kneading the mixture A to yield the kneaded product. The toner producing method preferably comprises the pulverizing step of pulverizing the kneaded product obtained in the melt-kneading step.

For example, the toner producing method may include: the step of pulverizing the kneaded product, so that the resultant has a desired particle diameter, and thereafter, sticking an inorganic fine particle to the surface of the toner particle in order to imparting flowability; and the step of adjusting the circularity of the toner by dispersion throughout an aqueous medium, and heating thereafter. The toner producing method may also include the step of adjusting the circularity of the toner particle by the use of a heat treating apparatus as shown in Japanese Patent Application Publication No. 2013-20244.

### Step of Mixing Raw Materials

In the step of mixing the raw materials, predetermined amounts of the binder resin, and the material to be dispersed over the binder resin are weighed and incorporated, and mixed to yield a mixture. A mixer as used herein is not particularly limited, and examples thereof include Henschel Mixer (manufactured by Nippon Coke & Engineering Co., Ltd.); Super Mixser (manufactured by Kawata Manufacturing Co., Ltd.); Ribocone (manufactured by Okawara Mfg. Co., Ltd.); Nauta Mixer, Turbulizer, and Cyclomix (manufactured by Hosokawa Micron Corporation); Spiral Pin Mixer (manufactured by Pacific Machinery & Engineering Co., Ltd.); and Lodige Mixer (manufactured by Matsubo Corporation).

Adding Water that Comprises Ultrafine Bubbles as Bubbles

As the means of containing the ultrafine bubble-containing water in the mixture, one may add the water into the mixer together with the binder resin in the step of mixing the raw materials; or one may add the water to the mixture mixed in the step of mixing the raw materials, and thereafter uniformly mix the resultant again using a mixer, or the like. The raw material mixture containing the ultrafine bubble-containing water is defined as a mixture 1.

### Melt-Kneading Step and Cooling Step

The toner raw materials including the mixture 1 is melt-kneaded with, for example, a twin-screw extruder. In the melt-kneading step, a batch kneader such as a pressure kneader and a Banbury mixer, or a continuous kneader can be used. In view of advantage in a continuous production capability, a single-screw or twin-screw extruder is preferable. The melt-kneading temperature is preferably approximately 100° C. to 200° C.

### Pulverizing Step

A kneaded product 1 obtained by melt-kneading the mixture 1 is further rolled with two rolls, or the like, and is cooled via a cooling step by, for example, water colling. Next, the kneaded product 1 after the cooling is pulverized to have a desired particle diameter in a pulverizing step. For example, in the pulverizing step, first, the kneaded product is coarsely pulverized with a crusher, a hammer mill, a feather mill, or the like. Further, the resultant product is finely pulverized with a mechanical pulverizer such as Inomiser (manufactured by Hosokawa Micron Corporation), Kryptron (manufactured by Kawasaki Heavy Industries, Ltd.), Super Rotor (manufactured by Nisshin Engineering Inc.), and Turbo Mill (manufactured by Freund-Turbo Corporation), and thereby, a finely pulverized product is obtained.

For example, a mechanical pulverizer as shown in the schematic view of the FIGURE may be used. When a predetermined amount of the coarsely pulverized product (product to be pulverized) is charged into a powder feeding port (powder charging port) 101 of the mechanical pulverizer shown in the FIGURE, the coarsely pulverized product having passed through a spiral casing 102 is introduced to a pulverizing chamber that is a gap between a rotor 103 and a stator 104. Then, the coarsely pulverized product is momentarily pulverized by the impact having occurred between the rotor 103 rotating around a pivot 107 at a high speed in the pulverizing chamber, which is provided with a large number of grooves on the surface thereof, and the stator 104, which is provided with a large number of grooves on the surface thereof. Thereafter, the finely pulverized product is discharged from a powder discharging port 106 via a latter chamber 105. The left side of the FIGURE is a schematic view of the cross section taken along the line D-D′.

The mechanical pulverizer is provided with a cold air generator 108 that supplies cold air together with the coarsely pulverized product, which is a product to be pulverized, into the device via the powder feeding port 101. The mechanical pulverizer is also provided with a cold water feeding port 109 and a cold water discharging port 110 for allowing water to flow into a cooling jacket with which the temperature of the device is controlled by cold water.

### Classifying Step

A classifying step here is the step of classifying the finely pulverized product obtained in the pulverizing step to yield the toner particle having a desired particle distribution.

As a classifier used for the classification, a known apparatus such as a wind force classifier, an inertial classifier, and a sieving classifier may be used, and specific examples thereof include Classiel, Micron Classifier, and Spedic Classifier (manufactured by Seishin Enterprise Co., Ltd.); Turbo Classifier (manufactured by Nisshin Engineering Inc.); Micron Separator, Turboplex (ATP), and TSP Separator (manufactured by Hosokawa Micron Corporation); Elbow Jet (manufactured by Nittetsu Mining Co., Ltd.); Dispersion Separator (manufactured by Nippon Pneumatic Industry Co., Ltd.); and YM Micro Cut (Yaskawa Co., Ltd.).

The toner particle prepared via the foregoing steps may be used as it is as the toner. If necessary, the toner may be formed by adding an inorganic fine particle such as silica, alumina, and titania, and/or a resin fine particle such as vinyl resins, polyester resins, and silicone reins to the toner particle by applying shearing force in a dry state. These inorganic fine particles and resin fine particles can serve as external additives such as a flow aid and a cleaning auxiliary.

The toner producing method may include the step of melt-kneading the pigment with part of the binder resin by using, for example, a twin-screw extruder, imparting shearing stress to the agglomerate of the pigment, and in addition, wetting the surface of the pigment particle with the binder resin. Through this step, a pigment dispersion (masterbatch) obtained by dispersing the pigment over part of the binder resin in advance can be produced. Next, in the method, the diluting and kneading step of melt-kneading and diluting the obtained pigment dispersion with the rest of the binder resin, and any other materials if necessary, so that the pigment dispersion has a predetermined pigment concentration is performed; thereby, the toner can be produced.

When the toner is produced after the aforementioned masterbatch is once produced, insufficient dispersibility of the pigment in the pigment dispersion may cause a coarse particle of the pigment that has approximately several to ten micrometers to be present. The coarse particle of the pigment in the pigment dispersion cannot be completely deagglomerated even by the successive step of diluting and melt-kneading, and remains in the toner. The presence of a low resistive component like the coarse particle of the pigment in the toner or on the surface of the toner tends to lead to progress in charge leakage from charged toner, and the decrease in charge quantity may cause toner scattering. Therefore, it is demanded to improve the dispersibility of the pigment, and to reduce the coarse particle of the pigment in the pigment dispersion more than the conventional.

Even when the masterbatch is once produced as described above, the UFB water is also preferably contained in the mixture when the masterbatch is produced by melt-kneading. It is considered that, thereby, the aforementioned compressive breaking action and surface action are taken, and the coarse particle of the pigment can be well deagglomerated.

That is, preferably, the melt-kneading step is a first melt-kneading step of melt-kneading the first mixture comprising part of the binder resin, and at least part of the pigment to yield a first kneaded product, and the first mixture is the mixture A. The toner producing method comprises a second melt-kneading step of melt-kneading the second mixture comprising at least the first kneaded product and the rest of the binder resin to yield a second kneaded product, after the first melt-kneading step.

Preferably, the UFB water is also comprised in the second mixture, that is, in a raw material mixture when the rest of the binder resin, and any other materials if necessary are melt-kneaded using the masterbatch. The UFB water also allows the material to be dispersed to be well dispersed in the second melt-kneading. The same one as comprised in the mixture A can be used as the UFB water here.

Therefore, preferably, the second mixture comprises 1.0 to 10.0 parts by mass of water to 100.0 parts by mass of the binder resin and the material to be dispersed in the second mixture in total,
the water comprised in the second mixture comprises bubbles comprising ultrafine bubbles having a particle diameter of not more than 1000 nm, and
the number of the ultrafine bubbles, which have a particle diameter of not more than 1000 nm, comprised in the water comprised in the second mixture is at least 1.0×10⁴ per milliliter.

In the second mixture, preferably, the number-average particle diameter of the bubbles in the water is also in the foregoing range.

The weight-average particle diameter (D4) of the toner is preferably from 3.0 μm to 20.0 μm, and more preferably from 4.0 to 10.0 μm.

In the mixture A (or the first mixture or second mixture), the value of the ratio of the content of the water (UFB water) to the content of the material to be dispersed on the basis of mass (water/material to be dispersed) is not particularly limited. The value of the ratio (water/material to be dispersed) is preferably 0.02 to 1.00, and more preferably 0.03 to 0.90. The foregoing range can lead to better dispersibility of the material to be dispersed.

### Method of Measuring Weight-Average Particle Diameter (D4) of Finely Pulverized Product and Toner

The weight-average particle diameter (D4) of the finely pulverized product and the toner (hereinafter simply referred to as the toner in this measurement method) is calculated by: measurement in 25,000 effective measurement channels by the use of a precision particle size distribution measurement instrument that is based on the pore electrical resistance method and is equipped with a 50-μm aperture tube, “Coulter Counter Multisizer 3” (registered trademark, manufactured by Beckman Coulter, Inc.), and accompanying dedicated software for setting the measurement conditions and analyzing the measurement data, “Beckman Coulter Multisizer 3 Version 3.51” (manufactured by Beckman Coulter, Inc.); and analysis of the measurement data.

As an aqueous electrolyte solution used for the measurement, special-grade sodium chloride dissolved in an ion exchanged water so that the concentration thereof is approximately 1 mass %, for example, “ISOTON II” (manufactured by Beckman Coulter, Inc.) may be used.

The dedicated software is set as follows prior to the measurement and the analysis.

In the “screen for modifying standard operating method (SOM)” of the dedicated software, the total count number for the control mode is set in 50000 particles, the number of times of the measurement is set in once, and the Kd value is set in the value obtained using “standard particle 10.0 μm” (manufactured by Beckman Coulter, Inc.). The threshold value and the noise level are automatically set by pressing the measurement button of the threshold value/noise level. The current is set in 1,600 μA, the gain is set in 2, the electrolyte solution is set in ISOTON II, and flushing the aperture tube after the measurement is checked.

In the “screen for setting conversion from pulses to particle diameter” of the dedicated software, the bin interval is set in the logarithmic particle diameter, the particle diameter bin is set in 256 particle diameter bins, and the particle diameter range is set to be from 1 μm to 30 km.

The specific measurement method is as follows.

(1) Approximately 200 mL of the aqueous electrolyte solution is put into a 250-mL round bottom glass beaker intended for use with the Multisizer 3. This beaker is placed in a sample stand, and subjected to counterclockwise stirring by the use of a stirrer rod at 24 rotations per second. The contamination and bubbles in the aperture tube are removed by the function of “flushing the aperture tube” of the dedicated software.

(2) Approximately 30 mL of the aqueous electrolyte solution is put into a 100-mL flatbottom glass beaker. Approximately 0.3 mL of the following dilution is added into this: the dilution is “Contaminon N” (10 mass % aqueous solution of a neutral pH 7 detergent for cleaning precision measurement instruments that is constituted of a nonionic surfactant, an anionic surfactant, and an organic builder, manufactured by Wako Pure Chemical Industries, Ltd.) as a dispersing agent diluted threefold on the basis of mass with an ion exchanged water.

(3) A prescribed amount of an ion exchanged water is put into a water tank of an ultrasonic disperser that has two built-in oscillators having an oscillation frequency of 50 kHz, and phases displaced by 180°, and has an electrical output of 120 W, “Ultrasonic Dispersion System Tetora 150” (manufactured by Nikkaki Bios Co., Ltd.), and approximately 2 mL of the aforementioned Contaminon N is added into this water tank.

(4) The beaker described in paragraph (2) is placed into a beaker holder opening of the ultrasonic disperser, and the ultrasonic disperser is started. The vertical position of the beaker is adjusted in such a manner that the resonance condition of the surface of the aqueous electrolyte solution in the beaker is at a maximum.

(5) While the aqueous electrolyte solution in the beaker described in paragraph (4) is subjected to ultrasonic irradiation, approximately 10 mg of the toner is added to the aqueous electrolyte solution little by little, and dispersed. The ultrasonic dispersion is continued for an additional 60 seconds. For the ultrasonic dispersion, the temperature of the water in the water tank is adjusted as appropriate to be from 10° C. to 40° C.

(6) The aqueous electrolyte solution where the toner is dispersed using a pipette, which is described in paragraph (5), is added dropwise into the round bottom beaker placed in the sample stand, which is described in paragraph (1), so that the measurement concentration is approximately 5%. The measurement is then performed until the number of measured particles reaches 50000.

(7) The measurement data is analyzed using the dedicated software accompanied with the instrument, and the weight-average particle diameter (D4) is calculated. The “average diameter” on the screen for the analysis/volume statistical value (arithmetic average) when graph/volume % is set in the dedicated software is the weight-average particle diameter (D4).

### EXAMPLES

Hereinafter the present disclosure will be described in more detail by using examples and comparative examples that however do not limit the present disclosure at all.

### Measuring Number-Average Particle Diameter of Bubbles, and UFB Number Density

The measurement of the number-average particle diameter of bubbles, and the UFB number density was as follows.

The average particle diameter of the bubbles in prepared UFB water was measured on the number basis by the use of a particle size distribution analyzer (trade name: SALD-7500nano, manufactured by Shimadzu Corporation). In this time, a batch cell (SALD-BC75) for SALD-7500nano that was connected to the measurement apparatus was filled with the UFB water, and the value of the refractive index of the particle was set in 1.25-0.00i (i was a complex number), and then, the measurement was performed. Analysis was performed using the accompanying software (WingSALDII), and the number-average particle diameter in the measurement range of 10 nm to 3000 nm was calculated.

The number density of the UFB of not more than 1000 nm was calculated using a nanoparticle tracking particle diameter measuring instrument (trade name: NanoSight NS300, manufactured by Malvern Panalytical). The UFB water was charged into a sample chamber of a Nanosight unit, and recorded on video at a frame rate of 25 fps for 60 seconds. The movement of the particles was analyzed using the accompanying software (NTA Software version 3.2), and thereby, the number density of the bubbles of 10 nm to 1000 nm (per milliliter) was calculated.

As for each of the undermentioned UFB waters 1 and 2, the value obtained by multiplying, by 100, the number density of diluted water obtained by 100-fold dilution with pure water was used as the number density.

### Preparing Ultrafine Bubble Water

Each UFB water was prepared by the following method. Table 1 shows the UFB waters used in the examples and the comparative examples.

### UFB Water 1

The UFB water 1 was a commercially available (study) UFB water (trade name: “high-density ultrafine bubble”, manufactured by NANOX CO., LTD.)

### UFB Waters 2 to 4

UFB waters 2 to 4 were each obtained by: diluting the UFB water 1 with pure water, or concentrating the UFB water 1 in vacuo with a rotary evaporator (N-1300E-W manufactured by TOKYO RIKAKIKAI CO., LTD.), and thereby, adjusting the UFB number density to the value in table 1.

### UFB Water 5

The one cycle of the following operation was repeated five times: air bubbles were contained in pure water by the use of a micro/nano bubble generator (OM4-MDG-05 manufactured by AURA TEC CO., LTD.) under the conditions of 25° C. and 1.8 L/min, which was repeated five times, and left still for 10 hours. After repeating the above cycle five times, the number density of the contained UFB was adjusted by dilution with pure water to yield UFB water 5.

### UFB Waters 6 and 7

UFB water 6 was prepared in the same manner as for the UFB water 5 except that the number of times of repeating the cycle was 1. UFB water 7 was obtained by further diluting the UFB water 6 with pure water to adjust the number density of the contained UFB.

### UFB Water 8

The following operation was performed once: air bubbles were contained in pure water by the use of a micro/nano bubble generator (OM4-MDG-05 manufactured by AURA TEC CO., LTD.) under the conditions of 25° C. and 1.2 L/min. The number density of the contained UFB was adjusted by dilution with pure water to yield UFB water 8.

TABLE 1

| | | UFB number density |
|---|---|---|
| | Particle diameter (nm) | (per milliliter) |
| UFB water 1 | 200 | 1.2 × 10⁹ |
| UFB water 2 | 200 | 3.0 × 10¹⁰ |
| UFB water 3 | 200 | 1.2 × 10⁶ |
| UFB water 4 | 200 | 6.0 × 10³ |
| UFB water 5 | 700 | 1.2 × 10⁶ |
| UFB water 6 | 950 | 1.2 × 10⁶ |
| UFB water 7 | 950 | 1.2 × 10⁴ |
| UFB water 8 | 1100 | 5.0 × 10³ |
| Pure water 1 | — | — |

In the table, the particle diameter shows the number-average particle diameter of the bubbles.

### Production Examples of Binder Resin L

polyoxypropylene(2.2)-2,2-bis(4-hydroxyphenyl)propane: 72.0 parts by mass (0.20 parts by mole)
terephthalic acid: 28.0 parts by mass (0.17 parts by mole)
tin 2-ethylhexanoate (catalyst used for esterification): 0.5 parts by mass

The above materials were weighed in a reaction vessel equipped with a cooling pipe, a stirrer, a nitrogen introducing pipe, and a thermocouple. Next, nitrogen gas was substituted in a flask, and thereafter, the temperature was gradually raised as stirring. The reaction was caused for 3 hours while stirring at a temperature of 200° C.

Further, the pressure in the reaction vessel was lowered to 8.3 kPa, and maintained for 1 hour. Thereafter, the temperature was cooled down to 180° C., and the pressure was returned to the atmospheric pressure.
trimellitic anhydride: 1.3 parts by mass (0.01 part by mole)
tert-butylcatechol (polymerization inhibitor): 0.1 part by mass

Thereafter, the above materials were added, and the pressure inside the reaction vessel was lowered to 8.3 kPa. The reaction was caused for 1 hour while the temperature was kept 180° C. After it was confirmed that the softening point measured conforming to ASTM D36-86 reached 85° C., the temperature was lowered to stop the reaction to yield a binder resin L.

### Production Example of Binder Resin H

polyoxypropylene(2.2)-2,2-bis(4-hydroxyphenyl)propane: 72.3 parts by mass (0.20 moles; 100.0 mol % of the total number of moles of polyhydric alcohols)
terephthalic acid: 18.3 parts by mass (0.11 moles; 65.0 mol % of the total number of moles of polycarboxylic acids)
fumaric acid: 2.9 parts by mass (0.03 moles; 15.0 mol % of the total number of moles of polycarboxylic acids)
tin 2-ethylhexanoate (catalyst used for esterification): 0.5 parts by mass

The above materials were weighed in a reaction vessel equipped with a cooling pipe, a stirrer, a nitrogen introducing pipe, and a thermocouple. Next, nitrogen gas was substituted in a flask, and thereafter, the temperature was gradually raised as stirring. The reaction was caused for 2 hours while stirring at a temperature of 200° C.

Further, the pressure in the reaction vessel was lowered to 8.3 kPa, and maintained for 1 hour. Thereafter, the temperature was cooled down to 180° C., and the pressure was returned to the atmospheric pressure.
trimellitic anhydride: 6.5 parts by mass (0.03 moles; 20.0 mol % of the total number of moles of polycarboxylic acids)
tert-butylcatechol (polymerization inhibitor): 0.1 part by mass

Thereafter, the above materials were added, and the pressure inside the reaction vessel was lowered to 8.3 kPa. The reaction was caused for 12 hours while the temperature was kept 160° C. After it was confirmed that the softening point measured conforming to ASTM D36-86 reached 132° C., the temperature was lowered to stop the reaction to yield a binder resin H.

### Producing Pigment Dispersion 1

pigment (magenta pigment: Pigment Red 122): 35.0 parts by mass
binder resin L: 65.0 parts by mass
UFB water 3: 5.0 parts by mass

The above materials were mixed using a Henschel mixer (FM-75 model manufactured by Nippon Coke & Engineering Co., Ltd.) at 20 s⁻¹ in rotation number for 5 min in rotation time, and thereafter, kneaded using a twin-screw kneader (PCM-30 model manufactured by Ikegai Corporation) at 120° C. (step 1). The obtained kneaded product was cooled and coarsely pulverized using a pin mill to have a weight-average particle diameter of not more than 100 μm to yield a coarsely pulverized product of a pigment dispersion 1. The melt viscosity of the binder resin L at 120° C. was 2080 Pa·sec.

### Producing Pigment Dispersions 2 to 9, and Comparative Pigment Dispersions 1 to 6

Pigment dispersions 2 to 9, and comparative pigment dispersions 1 to 6 were obtained in the same manner as for the pigment dispersion 1 except that the kinds and the number of parts of the UFB waters were changed as in table 2.

TABLE 2

| | | | | | | Number of |
|---|---|---|---|---|---|---|
| | | | | | | parts to |
| | | Number | | Number | | raw |
| Pigment dispersion No. | Binder resin | of parts | Pigment | of parts | Water | materials |
| Pigment dispersion 1 | Binder resin L | 65.0 | PR 122 | 35.0 | UFB water 3 | 5.0 |
| Pigment dispersion 2 | Binder resin L | 65.0 | PR 122 | 35.0 | UFB water 3 | 2.0 |
| Pigment dispersion 3 | Binder resin L | 65.0 | PR 122 | 35.0 | UFB water 3 | 8.0 |
| Pigment dispersion 4 | Binder resin L | 65.0 | PR 122 | 35.0 | UFB water 2 | 5.0 |
| Pigment dispersion 5 | Binder resin L | 65.0 | PR 122 | 35.0 | UFB water 5 | 5.0 |
| Pigment dispersion 6 | Binder resin L | 65.0 | PR 122 | 35.0 | UFB water 5 | 1.0 |
| Pigment dispersion 7 | Binder resin L | 65.0 | PR 122 | 35.0 | UFB water 5 | 10.0 |
| Pigment dispersion 8 | Binder resin L | 65.0 | PR 122 | 35.0 | UFB water 6 | 1.0 |
| Pigment dispersion 9 | Binder resin L | 65.0 | PR 122 | 35.0 | UFB water 7 | 1.0 |
| Comparative Pigment dispersion 1 | Binder resin L | 65.0 | PR 122 | 35.0 | Pure water | 5.0 |
| Comparative Pigment dispersion 2 | Binder resin L | 65.0 | PR 122 | 35.0 | UFB water 4 | 5.0 |
| Comparative Pigment dispersion 3 | Binder resin L | 65.0 | PR 122 | 35.0 | UFB water 8 | 5.0 |
| Comparative Pigment dispersion 4 | Binder resin L | 65.0 | PR 122 | 35.0 | — | 0.0 |
| Comparative Pigment dispersion 5 | Binder resin L | 65.0 | PR 122 | 35.0 | UFB water 5 | 0.6 |
| Comparative Pigment dispersion 6 | Binder resin L | 65.0 | PR 122 | 35.0 | UFB water 5 | 12.0 |

In the table, the number of parts is by mass. “Number of parts to raw materials” shows the number of parts by mass to 100.0 parts by mass of the binder resin and the material to be dispersed in total.

### Producing Finely Pulverized Product 1

binder resin L: 41.0 parts by mass
binder resin H: 20.0 parts by mass
pigment dispersion 1: 30.0 parts by mass
synthetic wax 1 (hydrocarbon wax, peak temperature of maximum endothermic peak: 90° C.): 9.0 parts by mass
UFB water 1: 5.0 parts by mass

The above materials were mixed using a Henschel mixer (FM-75 model manufactured by Nippon Coke & Engineering Co., Ltd.) at 20 s⁻¹ in rotation number for 5 min in rotation time, and thereafter, kneaded using a twin-screw kneader (PCM-30 model manufactured by Ikegai Corporation) (step 2). The obtained kneaded product was cooled and coarsely pulverized using a pin mill to have a weight-average particle diameter of not more than 100 μm to yield a coarsely pulverized product 1.

The obtained coarsely pulverized product 1 was pulverized using the mechanical pulverizer shown in the FIGURE (Turbo Mill T250-CRS, RS type in rotor shape, manufactured by Turbo Kogyo Co., Ltd.) under the conditions of 30 kg/h in feed in coarse pulverization, 150 m/s in peripheral velocity in rotation number of the rotor, 1.0 mm in gap between the rotor and the stator, −10° C. in cold air temperature, and 10 m³/min in cold air quantity, and thereby, a finely pulverized product 1 was obtained.

### Producing Toner 1

The finely pulverized product 1 was classified using a Coanda effect-based wind force classifier (“Elbow Jet Labo EJ-L3” manufactured by Nittetsu Mining Co., Ltd.) by adjusting various conditions such as an injection air quantity so that the target particle diameter and particle size distribution could be obtained, and a fine powder and a coarse powder were removed at the same time to yield a toner particle.

To 100 parts by mass of the obtained toner particle, 1.8 parts by mass of a silica fine particle that had a specific surface area measured by the BET method of 200 m²/g, and was subjected to hydrophobic treatment with a silicone oil was added, and the resultant was mixed using a Henschel mixer (FM-75 model manufactured by Nippon Coke & Engineering Co., Ltd.) at 30 s⁻¹ in rotation number for 10 min in rotation time to yield a toner 1. The weight-average particle diameter (D4) of the toner 1 was 5.5 m.

### Producing Toners 2 to 15, and Comparative Toners 1 to 7

Finely pulverized products 2 to 15, and comparative finely pulverized products 1 to 7 were obtained, and toners 2 to 15, and comparative toners 1 to 7 were obtained by further classifying the finely pulverized products in the same manner as in the production example of the finely pulverized product 1 and the toner 1 except that in the production of the toner 1, the types, and the numbers of parts of the added materials including binder resins and pigment dispersions were changed as in table 3. As in table 3, no pigment dispersions were used, but binder resins and pigments were used in the toners 5 to 14, and the comparative toners 1 to 6.

TABLE 3

| | Pigment dispersion | | Binder resin | | | |
|---|---|---|---|---|---|---|
| Toner | | Number | | Number | | Number |
| No. | No. | of parts | Type | of parts | Binder resin 2 | of parts |
| 1 | Pigment dispersion 1 | 30.0 | Binder resin L | 41.0 | Binder resin H | 20.0 |
| 2 | Pigment dispersion 1 | 30.0 | Binder resin L | 41.0 | Binder resin H | 20.0 |
| 3 | Pigment dispersion 1 | 30.0 | Binder resin L | 41.0 | Binder resin H | 20.0 |
| 4 | Pigment dispersion 1 | 30.0 | Binder resin L | 41.0 | Binder resin H | 20.0 |
| 5 | — | — | Binder resin L | 60.5 | Binder resin H | 20.0 |
| 6 | — | — | Binder resin L | 60.5 | Binder resin H | 20.0 |
| 7 | — | — | Binder resin L | 60.5 | Binder resin H | 20.0 |
| 8 | — | — | Binder resin L | 60.5 | Binder resin H | 20.0 |
| 9 | — | — | Binder resin L | 60.5 | Binder resin H | 20.0 |
| 10 | — | — | Binder resin L | 60.5 | Binder resin H | 20.0 |
| 11 | — | — | Binder resin L | 60.5 | Binder resin H | 20.0 |
| 12 | — | — | Binder resin L | 60.5 | Binder resin H | 20.0 |
| 13 | — | — | Binder resin L | 60.5 | Binder resin H | 20.0 |
| 14 | — | — | Binder resin L | 60.5 | Binder resin H | 20.0 |
| 15 | — | — | Binder resin L | 68.4 | Binder resin H | 22.6 |
| Comparative 1 | — | — | Binder resin L | 60.5 | Binder resin H | 20.0 |
| Comparative 2 | — | — | Binder resin L | 60.5 | Binder resin H | 20.0 |
| Comparative 3 | — | — | Binder resin L | 60.5 | Binder resin H | 20.0 |
| Comparative 4 | — | — | Binder resin L | 60.5 | Binder resin H | 20.0 |
| Comparative 5 | — | — | Binder resin L | 60.5 | Binder resin H | 20.0 |
| Comparative 6 | — | — | Binder resin L | 60.5 | Binder resin H | 20.0 |
| Comparative 7 | — | — | Binder resin L | 68.4 | Binder resin H | 22.6 |

| | Pigment | | Wax | | UFB water | |
|---|---|---|---|---|---|---|
| Toner | | Number | | Number | | Number of parts |
| No. | Type | of parts | Type | of parts | Type | to raw materials |
| 1 | — | — | Synthetic wax 1 | 9.0 | UFB water 3 | 5.0 |
| 2 | — | — | Synthetic wax 1 | 9.0 | UFB water 3 | 2.0 |
| 3 | — | — | Synthetic wax 1 | 9.0 | UFB water 3 | 8.0 |
| 4 | — | — | Synthetic wax 1 | 9.0 | UFB water 1 | 5.0 |
| 5 | PR 122 | 10.5 | Synthetic wax 1 | 9.0 | UFB water 1 | 5.0 |
| 6 | PR 122 | 10.5 | Synthetic wax 1 | 9.0 | UFB water 2 | 5.0 |
| 7 | PR 122 | 10.5 | Synthetic wax 1 | 9.0 | UFB water 3 | 5.0 |
| 8 | PR 122 | 10.5 | Synthetic wax 1 | 9.0 | UFB water 3 | 2.0 |
| 9 | PR 122 | 10.5 | Synthetic wax 1 | 9.0 | UFB water 3 | 8.0 |
| 10 | PR 122 | 10.5 | Synthetic wax 1 | 9.0 | UFB water 5 | 5.0 |
| 11 | PR 122 | 10.5 | Synthetic wax 1 | 9.0 | UFB water 5 | 1.0 |
| 12 | PR 122 | 10.5 | Synthetic wax 1 | 9.0 | UFB water 5 | 10.0 |
| 13 | PR 122 | 10.5 | Synthetic wax 1 | 9.0 | UFB water 6 | 1.0 |
| 14 | PR 122 | 10.5 | Synthetic wax 1 | 9.0 | UFB water 7 | 1.0 |
| 15 | — | — | Synthetic wax 1 | 9.0 | UFB water 3 | 5.0 |
| Comparative 1 | PR 122 | 10.5 | Synthetic wax 1 | 9.0 | Pure water | 5.0 |
| Comparative 2 | PR 122 | 10.5 | Synthetic wax 1 | 9.0 | UFB water 4 | 5.0 |
| Comparative 3 | PR 122 | 10.5 | Synthetic wax 1 | 9.0 | UFB water 8 | 5.0 |
| Comparative 4 | PR 122 | 10.5 | Synthetic wax 1 | 9.0 | — | 0.0 |
| Comparative 5 | PR 122 | 10.5 | Synthetic wax 1 | 9.0 | UFB water 5 | 0.6 |
| Comparative 6 | PR 122 | 10.5 | Synthetic wax 1 | 9.0 | UFB water 5 | 12.0 |
| Comparative 7 | — | — | Synthetic wax 1 | 9.0 | — | 0.0 |

In the table, the number of parts is by mass. “Number of parts to raw materials” shows the number of parts by mass to 100.0 parts by mass of the binder resin and the material to be dispersed in total.

### Production Example of Magnetic Carrier 1

magnetite 1 having a number-average particle diameter of 0.30 μm (65 Am²/kg in intensity of magnetization in a 1000/47c (kA/m) magnetic field)
magnetite 2 having a number-average particle diameter of 0.50 μm (65 Am²/kg in intensity of magnetization in a 1000/47c (kA/m) magnetic field)

To 100 parts of each of the above materials, 4.0 parts of a silane compound (3-(2-aminoethylaminopropyl)trimethoxysilane) was added. Each of the resultants was subjected to high-speed stirring in a vessel at 100° C. or higher, so that a fine particle therein was treated.
phenol: 10 mass %
formaldehyde solution: 6 mass % (40 mass % formaldehyde, 10 mass % methanol, and 50 mass % water)
magnetite 1 treated with the aforementioned silane compound: 58 mass %
magnetite 2 treated with the aforementioned silane compound: 26 mass %

Into a flask, 100 parts of the above materials, 5 parts of 28 mass % aqueous ammonia, and 20 parts of water were put. While stirring and mixing the resultant, the temperature was raised up to 85° C. in 30 minutes, and maintained. A polymerization reaction was caused for 3 hours, and the produced phenolic resin was cured. Thereafter, the cured phenolic resin was cooled to 30° C., and additional water was added. Thereafter, a supernatant was removed, and a precipitate was washed with water, and thereafter air-dried. The resultant was next dried in vacuo (at not more than 5 mmHg) at a temperature of 60° C. to yield a magnetic body-dispersed spherical magnetic carrier 1. The 50% particle diameter (D50) of the magnetic carrier 1 on a volume basis was 34.2 m.

### Production Example of Two-Component Developer 1

To 92.0 parts of the magnetic carrier 1, 8.0 parts of the toner 1 was added and mixed using a V-mixer (V-20 manufactured by Seishin Enterprise Co., Ltd.) to yield a two-component developer 1.

### Production Examples of Two-Component Developers 2 to 15, and Comparative Two-Component Developers 1 to 7

Two-component developers 2 to 15, and comparative two-component developers 1 to 7 were each obtained through the same operation as in the production example of the two-component developer 1 except that the combination of the toners in the developers was changed to the respective toners 2 to 15, and comparative toners 1 to 7.

### Example 1: Evaluation of Pigment Dispersion

The amount of the coarse particles of the pigment was evaluated by the following method by the use of the pigment dispersions 1 to 9 (example 1) and the comparative pigment dispersions 1 to 7 (comparative example 1).

### Method of Evaluating Dispersibility of Pigment in Pigment Dispersion

The evaluation was performed by: making a thin film of the pigment dispersion; observing the coarse particles of the pigment with an optical microscope; and thereafter obtaining the number of the coarse particles. First, 30 mg of the pigment dispersion was weighed, put into a powder forming die DD3015-0810 (NPa SYSTEM CO., LTD.), and pressurized using a small heat press machine (HC300-15 manufactured by AS ONE Corporation) at a pressure of 20 MPa for 20 seconds, and thereby, pellets of the pigment dispersion were prepared.

Next, the pellets were put on an OHP film (VF-1420N, KOKUYO Co., Ltd.), and NAFLON tape (TOMBO9001, NICHIAS Corporation) was put thereover. The resultant was set in the small heat press machine. After a pre-heat treatment was conducted at 150° C. for 1 minute 30 seconds, the resultant was pressurized at 10 MPa for 1 minute. Thereby, the thin film of the pigment dispersion was prepared.

When the prepared thin film of the pigment dispersion was observed with an optical microscope (VHX-5000, KEYENCE CORPORATION), oval agglomerates of the pigment of approximately several to 100 micrometers were observed darker than a background color. An image of the thin film of the pigment dispersion that was 1.6 mm×1.2 mm in field of view was obtained at a magnification of 300 times of the optical microscope. The number of the coarse particles of the pigment of at least 2 μm that were observed in the obtained image was counted using image processing software ImageJ as a pigment dispersion index, and the evaluation was performed by the following criteria. The evaluation results are shown in table 4.

### Evaluation Criteria

A: the number of the coarse particles of the pigment was smaller than 150
B: the number of the coarse particles of the pigment was at least 150 and smaller than 200
C: the number of the coarse particles of the pigment was at least 200 and smaller than 250
D: the number of the coarse particles of the pigment was at least 250 and smaller than 300
E: the number of the coarse particles of the pigment was at least 300

TABLE 4

| | | Pigment | |
|---|---|---|---|
| | | dispersion index | |
| | Masterbatch No. | (number) | Rank |
| Example 1 | Pigment dispersion 1 | 135 | A |
| | Pigment dispersion 2 | 145 | A |
| | Pigment dispersion 3 | 140 | A |
| | Pigment dispersion 4 | 130 | A |
| | Pigment dispersion 5 | 145 | A |
| | Pigment dispersion 6 | 180 | B |
| | Pigment dispersion 7 | 160 | B |
| | Pigment dispersion 8 | 220 | C |
| | Pigment dispersion 9 | 240 | C |
| Comparative | Comparative pigment dispersion 1 | 290 | D |
| example 1 | Comparative pigment dispersion 2 | 265 | D |
| | Comparative pigment dispersion 3 | 260 | D |
| | Comparative pigment dispersion 4 | 320 | E |
| | Comparative pigment dispersion 5 | 272 | D |
| | Comparative pigment dispersion 6 | 270 | D |

### Example 2: Evaluation of Toner

Pulverizability evaluation, and evaluation on tinting strength were conducted on the toners 1 to 15, and the comparative toners 1 to 7.

### Evaluation of Toner Pulverizability

When the particle diameter of a finely pulverized product prepared by a pulverizing means under the same conditions is smaller, the pulverizability when a toner is produced can be evaluated to be better. The weight-average particle diameter (D4) of each of the finely pulverized products before the toners 1 to 15, and the comparative toners 1 to 7 were obtained was measured using the aforementioned measurement method to yield the particle size distribution of the finely pulverized products 1 to 15, and the comparative finely pulverized products 1 to 7. The evaluation was conducted based on the weight-average particle diameters (D4) and by the following criteria. The evaluation results are shown in table 5.

### Evaluation Criteria

A: the weight-average particle diameter (D4) was smaller than 5.20 m
B: the weight-average particle diameter (D4) was at least 5.20 μm and smaller than 5.40 m
C: the weight-average particle diameter (D4) was at least 5.40 μm and smaller than 5.60 m
D: the weight-average particle diameter (D4) was at least 5.60 m

### Method of Evaluating Tinting Strength of Toner

The evaluation was conducted using a full-color copier, imageRUNNER ADVANCE C5255 manufactured by Canon, Inc. as an image forming apparatus, and by charging the two-component developer 1 into a developing device of a magenta station.

The evaluation environment was set in a normal temperature and a normal humidity (23° C., 50% RH). Plain paper for copy, CS-068 (A4 paper, basis weight: 68 g/m², on the market by Canon Marketing Japan Inc.) was used as evaluation paper.

First, in the foregoing evaluation environment, image output was produced in a condition where a developing bias was fixed, and the image density of the output image was checked. The image density was measured using X-Rite color reflection densitometer (series 500 manufactured by X-Rite).

From the result from the X-Rite color reflection densitometer, the tinting strength of the two-component developer 1 using the toner 1 was evaluated by the following criteria. Likewise, image output was produced using the two-component developers 2 to 15 and the comparative two-component developers 1 to 7 using the toners 2 to 15 and the comparative toners 1 to 7, respectively, and the tinting strength was evaluated based on the measured image densities and by the following criteria.

### Evaluation Criteria

A: the image density was at least 1.85
B: the image density was at least 1.75 and lower than 1.85
C: the image density was at least 1.65 and lower than 1.75
D: the image density was at least 1.55 and lower than 1.65
E: the image density and lower than 1.55

TABLE 5

| | | | | Pulverizability | | |
|---|---|---|---|---|---|---|
| | | | | | Particle | |
| | Tinting strength | | | | diameter D4 | |
| | | Image | | | after fine | |
| | | density | | | pulverization | |
| | Toner No. | [—] | Rank | Finely pulverized product No. | [μm] | Rank |
| Example 2 | Toner 1 | 1.88 | A | Finely pulverized product 1 | 5.15 | A |
| | Toner 2 | 1.86 | A | Finely pulverized product 2 | 5.16 | A |
| | Toner 3 | 1.87 | A | Finely pulverized product 3 | 5.13 | A |
| | Toner 4 | 1.89 | A | Finely pulverized product 4 | 5.13 | A |
| | Toner 5 | 1.83 | B | Finely pulverized product 5 | 5.12 | A |
| | Toner 6 | 1.84 | B | Finely pulverized product 6 | 5.09 | A |
| | Toner 7 | 1.82 | B | Finely pulverized product 7 | 5.15 | A |
| | Toner 8 | 1.81 | B | Finely pulverized product 8 | 5.17 | A |
| | Toner 9 | 1.82 | B | Finely pulverized product 9 | 5.14 | A |
| | Toner 10 | 1.81 | B | Finely pulverized product 10 | 5.18 | A |
| | Toner 11 | 1.76 | B | Finely pulverized product 11 | 5.36 | B |
| | Toner 12 | 1.77 | B | Finely pulverized product 12 | 5.32 | B |
| | Toner 13 | 1.72 | C | Finely pulverized product 13 | 5.55 | C |
| | Toner 14 | 1.66 | C | Finely pulverized product 14 | 5.51 | C |
| | Toner 15 | — | — | Finely pulverized product 15 | 5.15 | A |
| Compartive | Comparative Toner 1 | 1.58 | D | Comparative finely pulverized product 1 | 5.71 | D |
| Example 2 | Comparative Toner 2 | 1.61 | D | Comparative finely pulverized product 2 | 5.72 | D |
| | Comparative Toner 3 | 1.62 | D | Comparative finely pulverized product 3 | 5.72 | D |
| | Comparative Toner 4 | 1.53 | E | Comparative finely pulverized product 4 | 5.88 | D |
| | Comparative Toner 5 | 1.59 | D | Comparative finely pulverized product 5 | 5.73 | D |
| | Comparative Toner 6 | 1.60 | D | Comparative finely pulverized product 6 | 5.71 | D |
| | Comparative Toner 7 | — | — | Comparative finely pulverized product 7 | 5.89 | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-112858, filed Jul. 10, 2023 which is hereby incorporated by reference herein in its entirety.

What is claimed is:

1. A method of producing a toner, the method comprising:
a melt-kneading step of melt-kneading a mixture A comprising a binder resin, and a material to be dispersed over the binder resin to yield a kneaded product, wherein
the mixture A comprises 1.0 to 10.0 parts by mass of water to 100.0 parts by mass of the binder resin and the material to be dispersed in total,
the water comprised in the mixture A comprises bubbles comprising ultrafine bubbles having a particle diameter of not more than 1000 nm, and
the number of the ultrafine bubbles comprised in the water comprised in the mixture A is at least 1.0×10⁴ per milliliter.

2. The method of producing a toner according to claim 1, wherein
the method comprises a step of pulverizing the kneaded product.

3. The method of producing a toner according to claim 1, wherein
the material to be dispersed comprises a release agent.

4. The method of producing a toner according to claim 1, wherein
the material to be dispersed comprises a pigment.

5. The method of producing a toner according to claim 1, wherein
the material to be dispersed comprises a pigment and a release agent.

6. The method of producing a toner according to claim 1, wherein
the mixture A comprises 2.0 to 8.0 parts by mass of the water to 100.0 parts by mass of the binder resin and the material to be dispersed in total.

7. The method of producing a toner according to claim 1, wherein
a number-average particle diameter of the bubbles is not more than 1000 nm.

8. The method of producing a toner according to claim 1, wherein
a number-average particle diameter of the bubbles is not more than 700 nm.

9. The method of producing a toner according to claim 4, wherein
the melt-kneading step is a first melt-kneading step of melt-kneading a first mixture comprising part of the binder resin, and at least part of the pigment to yield a first kneaded product,
the first mixture is the mixture A, and
the method comprises a second melt-kneading step of melt-kneading a second mixture comprising at least the first kneaded product and a rest of the binder resin, after the first melt-kneading step.

10. The method of producing a toner according to claim 9, wherein
the second mixture comprises 1.0 to 10.0 parts by mass of water to 100.0 parts by mass of the binder resin and the material to be dispersed in the second mixture in total,
the water comprised in the second mixture comprises bubbles comprising ultrafine bubbles having a particle diameter of not more than 1000 nm, and
the number of the ultrafine bubbles comprised in the water comprised in the second mixture is at least 1.0×10⁴ per milliliter.
